(19) United States
(12) Patent Application Publication
(10) Pub. No.: US 2023/0191249 A1
(43) Pub. Date: Jun. 22, 2023

(54) INFORMATION PROCESSING METHOD, PROGRAM, INFORMATION PROCESSING SYSTEM

(71) Applicant: Akatsuki Inc., Tokyo (JP)

(72) Inventor: Qianwen HUANG, Tokyo (JP)

(21) Appl. No.: 17/938,546

(22) Filed: Oct. 6, 2022

(30) Foreign Application Priority Data
Dec. 20, 2021 (JP) 2021-206241

(51) Int. Cl. A63F 13/497; A63F 13/44; A63F 13/533

(52) U.S. Cl. CPC A63F 13/497; A63F 13/44; A63F 13/533; A63F 2300/308; A63F 2300/638

(57) ABSTRACT

According to an embodiment of the present invention, there is provided an information processing method by computer comprising: a step of acquiring operation information relating to an input operation inputted into a player terminal, a step of acquiring game image data relating to an image of a game application generated by the player terminal while the input operation is performed on the player terminal, a step of generating operation information reproduction data for visually displaying the input operation included in the operation information on the player terminal on the basis of the operation information, and a step of synchronizing the operation information reproduction data and the game image data associated with the operation information reproduction data in response to a reproduction request from the player terminal, and reproducing and displaying them on the player terminal.

### TECHNICAL FIELD

The present disclosure relates to an information processing method, a program and an information processing system.

### BACKGROUND ART

Patent Literature 1 discloses generating a replay video that makes it easy to understand the play situation by using game video data associated with log data including operation contents during play of the user.

### PRIOR ART LIST

### Patent Literature

Patent Literature 1: Japanese Unexamined Patent Publication No. 6947985

### SUMMARY OF THE INVENTION

### Techinical Problem

The log data including the operation contents of the user during play acquired in Patent Document 1 includes a command that the user inputs by pressing buttons on a game controller, and the moves that the in-game characters perform as a result, but does not include information indicating at what timing the user presses each button and inputs the commands. Recent games require complicated operations in which the user enters multiple commands continuously at a high speed. Particularly, in game applications that are executed on devices such as smartphones equipped with touch panels, a skillful input operation is required in which a player performs touch operations and swipe operations on the touch panel continuously or substantially simultaneously.

For example, a player who is excellent in input operation skills may need to teach other players the procedure of input procedures that the player has performed during its own game play. On the other hand, other players may need to improve their own input operation skills with reference to the procedure for input operation of players who are excellent in input operations and the procedure for input operation when the input operation was successful by themselves. The technology disclosed in Patent Literature 1 does not record the timing of input operations such as touch operations and swipe operations performed during the game play, and thus cannot meet the above needs.

Accordingly, an object of the present invention is to provide an information processing method and the like capable of reproducing input operations performed by a player during execution of a game application together with corresponding game images.

### Technical Solution

According to an embodiment of the present invention, there is provided an information processing method by computer comprising: a step of acquiring operation information relating to an input operation inputted into a player terminal; a step of acquiring game image data relating to an image of a game application generated by the player terminal while the input operation is performed on the player terminal; a step of generating operation information reproduction data for visually displaying the input operation included in the operation information on the player terminal on the basis of the operation information; and a step of synchronizing the operation information reproduction data and the game image data associated with the operation information reproduction data in response to a reproduction request from the player terminal, and reproducing and displaying them on the player terminal.

Other features and advantages of the present invention may be understood from the following description and the accompanying drawings that are given in an illustrative and non-exhaustive manner.

### Advantageous Effects

According to the present invention, there is provided an information processing method and the like that allows an input operation performed by a player during execution of a game application to reproduce together with a corresponding game image.

### BRIEF DESCRIPTION OF THE DRAWING

FIG. 1 is a diagram which shows a configuration example of a system according to an embodiment of the present invention;

FIG. 2 is a functional block diagram of the server device shown in FIG. 1;

FIG. 3 is a diagram which shows a data configuration example relating to owned characters according to an embodiment of the present invention;

FIG. 4 is a functional block diagram of the player terminal shown in FIG. 1;

FIG. 5 is a flowchart which explains an example of basic operation of the system in the present embodiment;

FIG. 6 is a diagram which shows an example of an RTS game screen displayed on the output unit (touch panel) of the player terminal in the present embodiment;

FIG. 7 is a diagram which shows an example in which the player performs a plurality of touch input operations on the touch panel of the player terminal on the game screen shown in FIG. 6;

FIG. 8 is a diagram which shows an example in which operation information reproduction data and game image data are reproduced and displayed on the output unit (touch panel) of the player terminal; and

FIG. 9 is a diagram which shows another example in which operation information reproduction data and game image data are reproduced and displayed on the output unit (touch panel) of the player terminal.

### DETAILED DESCRIPTION OF THE EMBODIMENTS

The contents of the embodiment of the present invention will be listed and described. The present disclosure has the following configuration.
[Item 1]

An information processing method by computer comprising:

a step of acquiring operation information relating to an input operation inputted into a player terminal;

a step of acquiring game image data relating to an image of a game application generated by the player terminal while the input operation is performed on the player terminal;

a step of generating operation information reproduction data for visually displaying the input operation included in the operation information on the player terminal on the basis of the operation information; and

a step of synchronizing the operation information reproduction data and the game image data associated with the operation information reproduction data in response to a reproduction request from the player terminal, and reproducing and displaying them on the player terminal.
[Item 2]

The information processing method according to Item 1, wherein the step of generating operation information reproduction data includes allowing display time information for displaying a visualization display corresponding to each of the input operations included in the operation information in accordance with input time information of each of the input operations to be included in the operation information reproduction data.
[Item 3]

The information processing method as in Item 1 or 2, wherein the step of generating operation information reproduction data includes allowing display position information for displaying a visualization display corresponding to each of the input operations included in the operation information in accordance with input position information of each of the input operations to be included in the operation information reproduction data.
[Item 4]

The information processing method as in any one of Items 1 to 3, further comprising:

a step of receiving an input operation inputted into the player terminal while the operation information reproduction data and the game image data are reproduced; and

a step of comparing the input operation with the input operation included in the operation information reproduction data and presenting the comparison result.
[Item 5]

The information processing method as in any one of claims 1 to 4, further comprising a step in which an input operation inputted into a player terminal while the operation information reproduction data and the game image data are reproduced, is visually displayed in the output of the player terminal along with the visualization display of the input operation included in the operation information reproduction data.
[Item 6]

The information processing method as in any one of claims 1 to 5, further comprising:

a step of acquiring player evaluation information inputted into the player terminal that has reproduced the operation information reproduction data and the game image data;

a step of storing the player evaluation information for the reproduced operation information reproduction data in a storage unit in association with the operation information reproduction data; and

a step of presenting a plurality of the operation information reproduction data stored in the storage unit to the player terminal together with the associated player evaluation information.
[Item 7]

A program for making a computer execute an information processing method, the information processing method comprising:

a step of acquiring operation information relating to an input operation inputted into a player terminal;

a step of acquiring game image data relating to an image of a game application generated by the player terminal while the input operation is performed on the player terminal;

a step of generating operation information reproduction data, based on the operation information, for visually displaying the input operation included in the operation information on the player terminal;

a step of synchronizing the operation information reproduction data and the game image data associated with the operation information reproduction data in response to a reproduction request from the player terminal, and reproducing and displaying them on the player terminal.
[Item 8]

An information processing system having a control unit, in which the control unit is configured so as to include:

acquiring operation information related to an input operation inputted into a player terminal;

acquiring game image data relating an image of a game application generated by the player terminal while the input operation is performed on the player terminal;

generating operation information reproduction data for visually displaying the input operation included in the operation information on the player terminal based on the operation information; and

synchronizing the operation information reproduction data and the game image data associated with the operation information reproduction data in response to a reproduction request from the player terminal, and reproducing and displaying them on the player terminal.

Hereinafter, embodiments of the present invention will be described with reference to the drawings.

<Configuration>

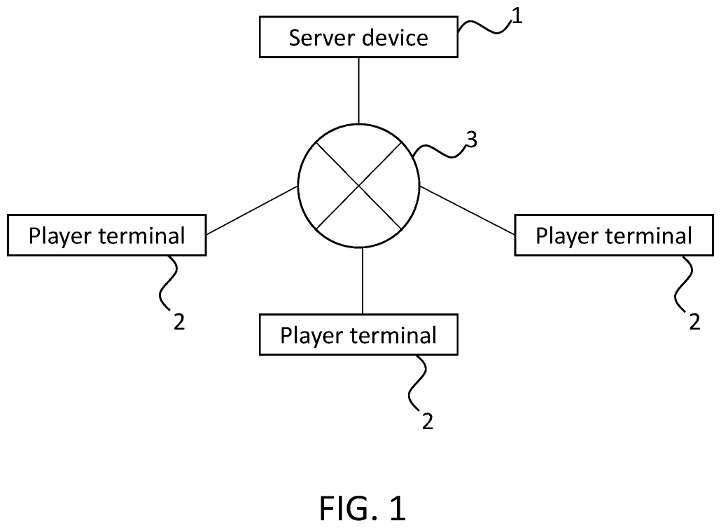

FIG. 1 is a diagram which shows a configuration example of a system according to an embodiment of the present invention. As shown in FIG. 1, the game system provides various services relating to games to players (hereinafter also referred to as “users”) via a network 3 (for example, the Internet), and has a server device 1 and a plurality of player terminals 2.

<Configuration of Server Device 1>

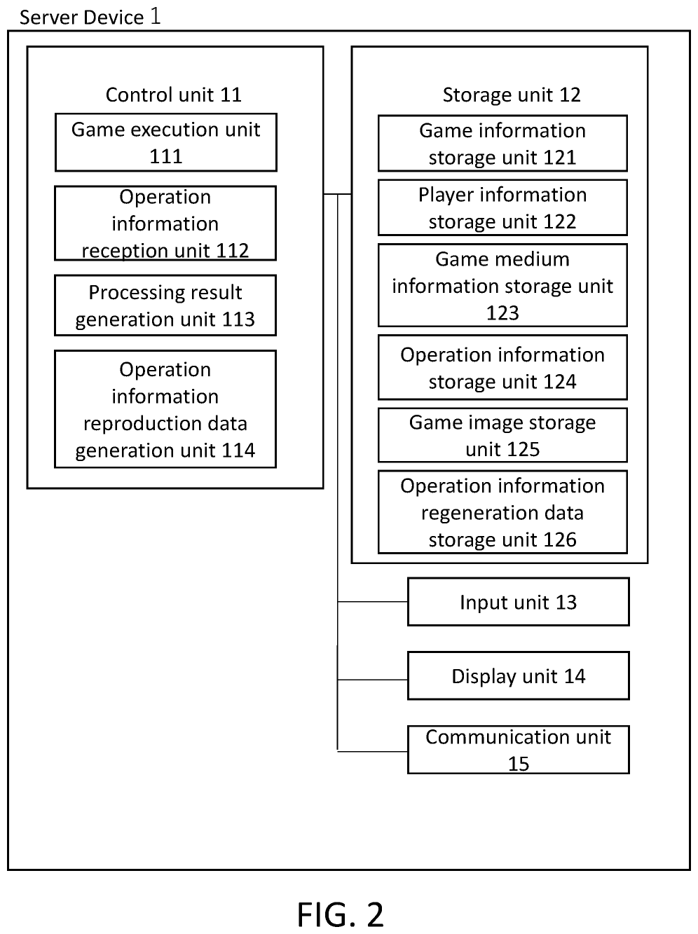

FIG. 2 is a functional block diagram of the server device 1 shown in FIG. 1. The server device 1 is an information processing device used by a system administrator or the like to manage and control various services, and may be, for example, a general-purpose computer such as a workstation or personal computer, or may be logically realized by cloud computing technology.

The server device 1 has a control unit 11, a storage unit 12, an input unit 13, a display unit 14 and a communication unit 15. The server device 1 executes processing by the game program in the control unit 11, when receiving various commands (requests) from the player terminal 2 via the communication unit 15, and the processing result of the game program (e.g., game image, game sound, etc.) is transmitted to the player terminal 2. Further, a part of the game program may be transmitted to the player terminal 2 and executed on the player terminal 2.

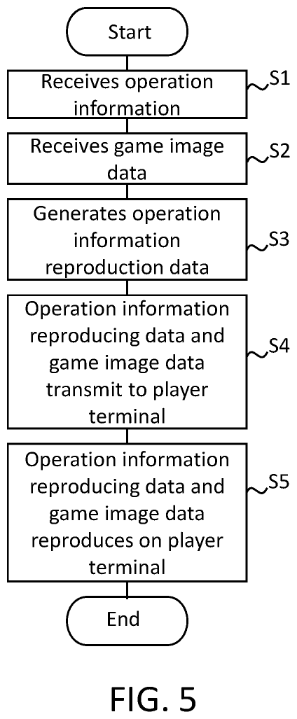

The control unit 11 transfers data between units and, at the same time, controls the entire server device 1, and it is realized by executing a program stored in a predetermined memory by a CPU (Central Processing Unit) or a GPU (Graphics Processing Unit). The control unit 11 is configured to operate so as to realize the processing and functions performed by the server device 1 as will be described with reference to FIG. 5. The control unit 11 of the present embodiment includes at least a game execution unit 111, an operation information reception unit 112, a processing result generation unit 113, and an operation information reproduction data generation unit 114.

The game execution unit 111 has a function of executing a process for progressing the game in accordance with the game program. The game by the game system in the present embodiment may be any type of game, and examples thereof may be a battle game, a puzzle game, an action game, a baseball game, a soccer game, other sports games, a quiz game, a pinball game, a card game, a rhythm game, an RPG, and the like.

The operation information reception unit 112 receives the operation information transmitted from the player terminal 2. The received operation information is used as instruction information for processing the game program by the game execution unit 111. As an example, a touch panel is adopted as the output unit 24 of the player terminal 2 as described later, and when the surface of the touch panel also functions as the input surface of the input unit 23, a tap operation or a swipe operation on the touch panel is transmitted from the player terminal 2 as operation information. In this case, the operation information includes a tap input position of the tap operation on the touch panel, an input start position of the swipe operation, a swipe trajectory, an input end position, and the like. The operation information further includes input time information for each operation (tap input time of tap operation, input start time and input end time of swipe operation, etc.). The input time information may be, for example, a time stamp along the time axis based on the universal standard time, or may be a time stamp along the unique time axis of the server device 1.

The processing result generation unit 113 has a function of executing processing for generating the processing result of the game program executed by the game execution unit 111. The generated processing result is transmitted to the player terminal 2 by the processing result generation unit 113 and is outputted by the output unit 24, which will be described later.

Based on the operation information received by the operation information receiving unit 112 from the player terminal 2, the operation information reproduction data generation unit 114 has a function of executing processing for generating operation information reproduction data for displaying graphics corresponding to each input operation included in the operation information on the output unit 24 of the player terminal 2 in synchronization with the game image (in the description of the present specification and claims, “images” can mean both still images and moving images.). The operation information reproduction data includes a graphic for visually displaying each input operation included in the operation information, and a display time information indicating the timing of displaying the graphic. The input time information of each input operation included in the operation information can be used as the display time information indicating the timing of displaying the graphics. The operation information reproduction data has, for example, the same time span as the time span from the storage start to the storage end of operation information, which will be described later. A unique ID is assigned to each operation information reproduction data.

The generated operation information reproduction data preferably further includes a game information for specifying a game program in which operation information was inputted, and a player ID of the player logged into the player terminal 2 where the operation information was inputted. The operation information reproduction data may further include stage information of the game in which operation information was inputted and a tag information that indicates the enemy character that was defeated, etc.

In addition, similarly to the case of the input time information of the operation information described above, the game image data generated by the game operation unit 212 can be generated, for example, along a time axis based on the world standard time or along a time axis unique to the server device 1, but the time axis of the game image data is preferably the same as the time axis of the operation information. The operation information reproduction data and the game image data can be synchronized, for example, using a common arbitrary time.

The operation information reproduction data may be configured, for example, in the form of a table that associates graphic data for visually displaying each input operation included in the operation information and display time information that indicates the timing of displaying the graphic data. Alternatively, they may be configured in the form of one data file combining them. The generated operation information reproduction data is used to transmit to the player terminal 2 together with the corresponding game image in response to a request from the player terminal 2 as will be described later, and to output to the output unit 24 of the player terminal 2 together with the game image. The operation information reproduction data is reproduced in the output unit 24 of the player terminal 2 in synchronization with the game image data transmitted to the player terminal 2 together with the operation information reproduction data, for example. At this time, the graphic (e.g., an image of “●” with any colour or decoration) included in the operation information reproduction data is displayed on the output unit 24 of the player terminal 2 at the position and timing within the screen where each corresponding input operation was performed.

The storage unit 12 has a non-volatile storage device that is a read-only storage area in which a system program is stored, and a volatile storage device that is a rewritable storage area used as a work area for arithmetic processing by the control unit 11. The non-volatile storage device is realized by, for example, a ROM (Read Only Memory), a flash memory, a hard disk, or the like, and the volatile storage device is realized by RAM (Random Access Memory), VRAM (Video Random Access Memory), or the like. The storage unit 12 stores a program that causes the control unit 11 to execute processing performed by the server device 1, which will be described with reference to FIG. 5 and the like. The storage unit 12 in the present embodiment has various storage units including at least a game information storage unit 121, a player information storage unit 122, a game medium information storage unit 123, an operation information storage unit 124, a game image storage unit 125, an operation information reproduction data storage unit 126, and the like.

The game information storage unit 121 stores information relating to the game. The game information is appropriately configured according to the type of game. For example, in the case of a game including a quest game, the stage name, enemy character information, consumption stamina information, and the like are included in association with the stage ID.

The player information storage unit 122 stores information relating to the player. The player information can include information such as a player name, a player level, current stamina information, upper limit stamina information, play stage information, a payment method, various setting information, and the like that are linked with the player ID, and additionally, may further include information relating to the player and game play situation. The current stamina information is information indicating the numerical value of the player's stamina that is currently consumable. The upper limit stamina information is information indicating an upper limit value at which stamina recovers every time a predetermined time elapses, or in accordance with the use of an item, the use of a character's special ability, or the like. The play stage information is information about a stage that the player has played so far among the set stages, and can include the number of times played, clear information, and the like. The various setting information includes, for example, automatic progress setting information, and when the automatic progress setting information is on, the event described later can be progressed without the player's operation via the player terminal 2.

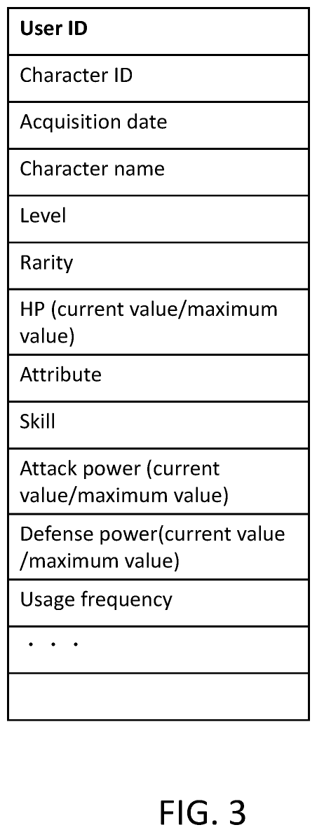

The game medium information storage unit 123 stores game medium information such as characters and items owned by the player. FIG. 3 is a diagram which shows a data configuration example relating to owned characters in the game medium information storage unit 123. The owned character information may include values of various parameters such as acquisition date and time, a character name, level, rarity, HP (current value/maximum value), an attribute, a skill, an attack power (current value/maximum value), a defense power (current value/maximum value), a usage frequency, in association with the ID of each owned character. The acquisition date and time are information related to the date and time when the character was assigned to the player as a result of the progress of the game or the execution of the lottery. The rarity is information relating to the probability of winning, for example, in a lottery game of a character. The HP, attack power, and defense power may include the “maximum value” when the character is raised to the maximum level, along with the “current value”, which is the current value. The attribute is setting information related to other character classifications, such as classifications indicating the character's strengths, such as fire attribute, water attribute, or wind attribute for battle games, and classifications that indicate the team or the position to which a sports game belongs. The skill is information such as a special skill that a character can use. The usage frequency is information relating the frequency in which the player has selected or used the character in the past. The usage frequency may be calculated over the entire period since the player started the game or may be calculated over any period such as the last few months. Further, the game medium information may include information relating to owned items in addition to owned characters. The owned item information may include information such as the number of owned items in association with the ID of the owned item. Further, the server device 1 may hold, as a storage unit, information contained in the game information, player information, and game medium information in a predetermined structure, and it does not need to necessarily hold information as each of the storage units 121 to 123 as described above.

The operation information storage unit 124 stores operation information received by the operation information reception unit 112 from the player terminal 2. As described above, the operation information includes input time information at which each operation (tap operation, swipe operation, etc.) is inputted to the input unit 23 of the player terminal 2, and thus is stored in the operation information storage unit 124. The operation information also includes input time information for each operation. For example, the operation information storage unit 124 stores operation information from the recording start time at which recording starts with the start of game play on the player terminal 2 to the recording end time at which recording ends with the end of game play, or operation information from the storage start time when the recording start instruction is inputted by the player through the input unit 23 of the player terminal 2 to the storage end time when the recording end instruction is inputted.

The game image storage unit 125 stores game image data generated as a result of operating the game by the game operation unit 212 in the control unit 21 of the player terminal 2. The game image data transmitted from the player terminal 2 is received by the communication section 15 of the server device 1 and stored in the game image storage section 125 of the storage unit 12. Just as with the operation information above, the game image storage unit 125 stores, for example, game image data from the recording start time at which recording starts with the start of game play on the player terminal 2 to the recording end time at which recording ends with the end of game play, or, game image data from the storage start time at which a recording start instruction is inputted by the player through the input unit 23 of the player terminal 2 to the storage end time at which the recording end instruction is inputted. The storage start time and storage end time of the game image data are preferably the same as the storage start time and storage end time of the corresponding operation information.

The game image storage unit 125 may store game music/audio data generated as a result of operating the game by the game operation unit 212 of the player terminal 2. The game music/audio data is preferably stored in the game image storage unit 125 in association with the corresponding game image data.

The operation information reproduction data storage unit 126 stores the operation information reproduction data generated by the operation information reproduction data generation unit 114. As described above, the operation information reproduction data is stored in the operation information reproduction data storage unit 126, for example, in the form of a table that associates a graphic for starting and displaying each input operation included in the operation information with display time information that indicates the timing of displaying the graphic, or the form of one data file in which they are synthesized.

The operation information reproduction data storage unit 126 includes, for example, an association table that associates a unique ID of operation information reproduction data with a unique ID of game image data corresponding to the operation information reproduction data. Thereby, the operation information reproduction data and the game image data generated as a result of inputting the operation information from which the operation information reproduction data is generated are stored in the storage unit 12 in a state of being associated with each other. The association between the operation information reproduction data and the game image data corresponding to the operation information reproduction data can be performed, for example, by configuring so that mutual association of the recording start time and the recording end time as the same date is determined by the operation information reproduction data generation unit 114.

The input unit 13 is for inputting various data (e.g., game information, etc.) relating to the game service by the system administrator, and is realized by, for example, a keyboard and mouse, or the like.

The display unit 14 is for displaying an operation screen for the system administrator based on a command from the control unit 11, and is realized by, for example, a liquid crystal display (LCD).

The communication unit 15 is for communicating with the player terminal 2 via the network 3, and has the function as a receiving unit for receiving various data, signals, and commands transmitted from the player terminal 2, and the function as a transmitting unit for transmitting various data and signals to the player terminal 2 according to commands from the control unit 11. The communication unit 15 communicates with the player terminal 2 using, for example, HTTP (HyperText Transfer Protocol), HTTPS, WebSocket, P2P (Peer to Peer), or the like.

<Player Terminal 2>

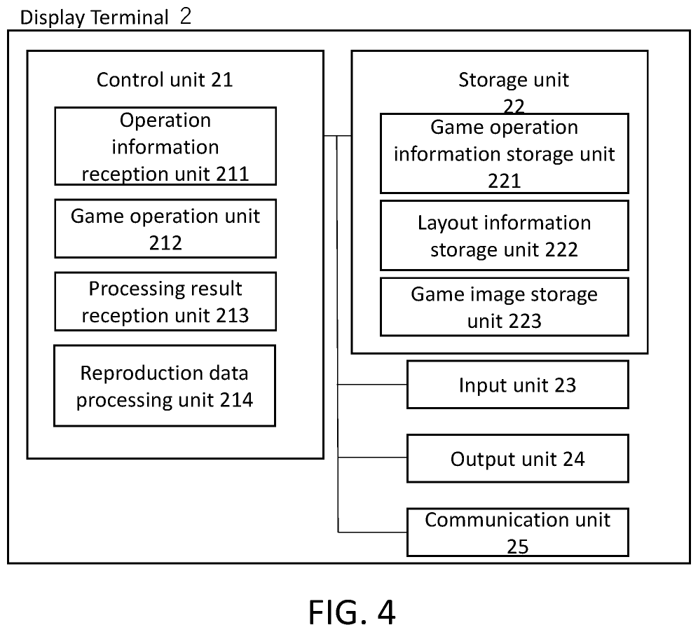

FIG. 4 is a block diagram showing the functional configuration of the player terminal 2 shown in FIG. 1. The player terminal 2 is an information processing device that the player can possess and use (for example, a computer device such as a smartphone, a mobile phone terminal, or a tablet terminal). The player terminal 2 can output (for example, game screen display, game sound output, etc.) the processing result of the game program transmitted from the server device 1 via a game application or a web browser. The player terminal 2 has a control unit 21 for controlling the entire player terminal 2, a storage unit 22 for storing various data programs, an input unit 23 for the player to perform operation input, an output unit 24 for outputting game screens, operation screens, etc., and a communication unit 25 that performs information communication with the server device 1.

The control unit 21 controls the overall operation of the player terminal 2 by executing programs stored in the storage unit 22, and is composed of a CPU, a GPU, and the like. The control unit 22 of the present embodiment is configured to operate so as to implement the processing and its functions performed by the player terminal 2 as described with reference to FIG. 5 and the like.

The storage unit 22 stores programs, input data, and the like for executing various control processes and functions in the control unit 21, and is composed of one or any combination thereof, such as RAM, ROM, flash memory, HDD, SSD, and other storage. In addition, the storage unit 22 temporarily stores the communication contents of the server device 1. The storage unit 22 of the present embodiment stores a program that causes the control unit 22 to execute processing performed by the player terminal 2, which will be described with reference to FIG. 5 and the like.

The control unit 21 of the present embodiment includes at least an operation information reception unit 211, a game operation unit 212, a processing result reception unit 213 and a reproduction data processing unit 214. Further, the storage unit 22 also includes at least a game operation information storage unit 221, a layout information storage unit 222, and a game image storage unit 223. The layout information storage unit 222 stores information relating to the layout of the configuration disposed on each screen of the game. Each functional unit of the control unit 21 can be realized by the CPU or GPU executing a program stored in the memory or the game operation information storage unit 221.

The operation information reception unit 211 receives an operation related to the game using the input unit 23 by the player. Then, the operation information reception unit 211 outputs the received operation contents to the game operation unit 212 or the server device 1.

The input unit 23 has a function of receiving input from the player. The input unit 23 in the present embodiment has an input surface capable of detecting a touch input by the player, and has a function of receiving an input from the player and transmitting the content of the input to the control unit 21. For example, when a touch panel is adopted as the output unit 24 of the player terminal 2, the surface of the touch panel also functions as an input surface of the input unit 23. The input unit 23 detects touch input by the player and transmits the input information to the control unit 21. Touch inputs include, but are not limited to, touch, long touch, multi-touch, release, swipe, tap, double tap, long tap, drag, flick, and the like. The input unit 23 may have a physical button in addition to the touch panel as described above.

Here, as an example, “touch” refers to an operation or state in which the player's finger, a stylus pen, or the like comes into contact with the input surface of the input unit 23. In addition, the “swipe” refers to an operation of sliding the player's finger or the stylus pen or the like in a certain direction over a certain distance while touching the input surface of the input unit 23 with the finger or the stylus pen.

The input unit 23 determines the type of touch input based on a contact with the input surface of the input unit 23 such as a finger or a stylus pen, a contact position on the input surface of the input unit 23, a contact time, or a contact count. For example, when a swipe is performed as a touch input, the input unit 23 detects the first touched point (start point) and the touched away point (end point) on the input surface (surface of the touch panel), and transmits the input information to the control unit 21. Based on the input information, the control unit 21 specifies the direction from the start point to the end point as the direction specified by the player.

Swipe is used for performing an operation that moves an object such as a character or an icon in the screen displayed on the output unit 24 to a desired direction or position, an operation that pushes the means of attack provided by the character in a desired direction (an operation performed by determining the shooting direction of bullets, missiles, etc., or the direction of swinging down swords, axes, etc.), and an operation that scrolls the screen in a desired direction, but is not limited to such operations.

The game operation unit 212 executes processing for operating the game application. The game operation unit 212 starts and operates the game based on the game software included in the game operation information stored in the game operation information storage unit 221 and the operation contents of the player inputted from the input unit 23. The game operation unit 212 generates an image for the game from the image data included in the game operation information and performs control processing for outputting the generated image to the output unit 24 in accordance with the game operation. Similarly, the game operation unit 212 generates game music and sound from the music data and sound data included in the game operation information in accordance with the game operation, and causes the output unit 24 to output the generated music and sound. Further, here, the description has been given about a configuration in which a native application partially executes the function of a web application, that is, the game operation unit 212 of the player terminal 2 partially executes the function of the processing result generation unit 113 of the server device 1. As will be described later, the processing result generation unit 113 may be configured to generate all game images and sounds as processing results without having the game operation unit 212, or it may be configured so as to generate generates all game images and sounds by the game operation unit 212.

In the case of having the game operation unit 212, the predetermined parameters in the game operated by the game operation unit 212 are managed by the server device 1. For example, parameters such as stamina in the game and in-game currency are managed by the server device 1. Therefore, the game operation unit 212 updates parameters managed by the server device 1 by communicating with the server device 1 if the game involves a process involving changes in these predetermined parameters. Then, the game operation unit 212 receives the updated parameters from the server device 1 and continues the game operation based on the updated parameters.

If the server device 1 has the processing result generation unit 113, the processing result reception unit 213 operates to receive the processing result generated and transmitted by the processing result generation unit 113 and output it to the player via the output unit 24.

The reproduction data processing unit 214 performs processing for requesting transmission of operation information reproduction data to the server device 1 according to an input operation of the input unit 23 by the player operating the player terminal 2, and as a result, receives the operation information reproduction data and the game image data transmitted from the server device 1 to the player terminal, synchronizes them and outputs to the output unit 24. Thereby, the operation information reproduction data is reproduced and displayed on the output unit 24 of the player terminal 2 together with the game image data.

In the game operation information storage unit 221 in the present embodiment, various touch inputs that can be inputted on the input unit 23 of the player terminal 2 (touch, long touch, multi-touch, release, swipe, tap, double tap, long tap, drag, and flick, etc.) and commands specified by each touch input are stored in association with each other. Commands associated with a certain touch input are not limited to one. For example, the same touch input may be associated with different commands depending on the different game screens on which it is inputted. Further, commands may be associated with a series of two or more touch inputs.

The layout information storage unit 222 may be provided in the server device 1 instead of the player terminal 2, or may be provided in different hardware configurations (for example, server device 1, player terminal 2, etc.).

In the case of having the game image storage unit 223, the game image data generated by the game operation unit 212 is at least temporarily stored in the game image storage unit 223. The game image storage unit 223 stores, for example, the game image data from the start of storage to the end of storage instructed by the user via the input unit 23 of the player terminal 2. Further, the game image storage unit 223 may at least temporarily store the game music/sound generated as a result of the game operation unit 212 operating the game in association with the corresponding game image. The game image and game music/sound stored in the game image storage unit 223 are transmitted to the server device 1 via the communication unit 25 of the player terminal 2.

The game system in the present embodiment relates to a mechanism that enables the server device 1 to generate operation information reproduction data based on the operation information received from the player terminal 2 and reproduce the operation information reproduction data together with the corresponding game image data on the player terminal 2. An example of basic operation of the game system in the present embodiment will be described with reference to FIG. 5 and the like.

FIG. 5 is a flowchart which explains an example of basic operation of the system in the present embodiment.

The server device 1 receives, from the player terminal 2, operation information inputted to the input unit 23 (touch panel) of the player terminal 2 (step S1).

During operation of the game system (that is, during execution of game-related processing between the server device 1 and the player terminal 2), when a touch input is performed by a user operation on the input unit 23 (touch panel) of the player terminal 2, the operation information reception unit 211 of the player terminal 2 receives operation information related to the touch input, and the control unit 21 of the player terminal 2 transmits the operation information to the server device 1 via the communication unit 25. As described above, the operation information related to touch input includes the tap input position of the tap operation on the input unit 23 (touch panel) of the player terminal 2, the input start position of the swipe operation, the swipe trajectory, the input end position, and the like, and further include the input time information of each touch input (tap input time of tap operation, input start time and input end time of swipe operation, etc.).

The server device 1 is preferably configured so that a mode in which operation information from the start to the end of game play is stored in the operation information storage unit 124, and a mode in which operation information from the recording start time to the recording end time instructed by the player during game play is stored in the operation information storage unit 124 can be selected in advance by an input operation via the input unit 23 of the player terminal 2 before the player starts playing the game. In the latter case, the player inputs a recording start instruction and a recording end instruction, respectively, via the input unit 23 during game play, whereby operation information can be recorded at a desired timing and at a desired time interval. The operation information storage unit 124 of the server device 1 stores, for example, an operation information from a recording start time at which recording is started along with the start of game play on the player terminal 2 to a recording end time at which recording ends along with the end of the game play, or operation information from the storage start time when the recording start instruction is inputted by the player through the input unit 23 of the player terminal 2 to the storage end time when the recording end instruction is inputted. The operation information transmitted from the player terminal 2 may be received by the communication unit 15 of the server device 1 via the network 3 and stored in the operation information storage unit 124 of the server device 1 in a state to which a unique ID is assigned.

Here, an example of operation information related to a touch input performed by a user operation on the input unit 23 (touch panel) of the player terminal 2 is described in the context of playing a genre of game called so-called real-time strategy (hereinafter referred to as “RTS”). In general, RTS games are set with the goal of appropriately disposing of their own characters (also called units, etc.) to make a sortie against enemy territories and positions, letting the character attack an attack target such as an enemy soldier, battery, or fortress, attacking enemy territories and positions one after another, acquiring resources and expanding their own power. In the RTS game, after the operation to place the character is performed, the process, which comprises performing the attack toward the nearest attack target from the position where the character was placed, and moving to the next nearest attack target and performing the attack if the attack of the attack target is completed, are automatically repeated until the attack against all attack targets within the enemy's territory or position is completed. In such an RTS game, it is the key to game strategy that the character for making a sortie is selected according to the layout of the attack target in the enemy's territory or position, or the progress of the attack by the character, and the like, and an input operation is performed to dispose them in an appropriate position and timing.

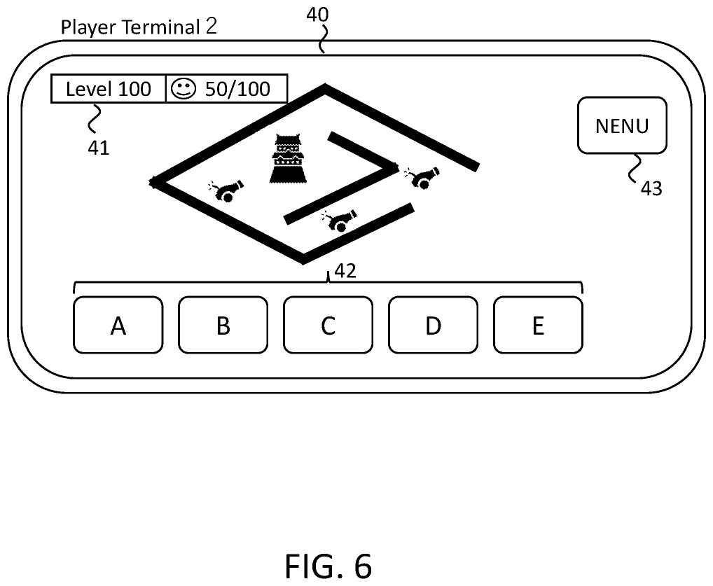

FIG. 6 is a diagram which shows an example of an RTS game screen displayed on the output unit (touch panel) of the player terminal in the present embodiment.

In the example shown in FIG. 6, on the screen outputted on the output unit 24 (touch panel 40) of the player terminal 2, a player information display section 41, a character (unit) selection section 42, and a function selection operation section 43 are disposed based on the layout information stored in the layout information storage section 222. In addition to this, the screen depicts an enemy castle to be attacked, three artillery batteries and a castle wall as part of the game image. In addition, the contents disposed on the screen are not limited to those illustrated in FIG. 6, and may include other information, and the number and shape of each structure are not limited to those illustrated.

The player information display unit 41 displays, for example, player information (e.g., player level, current stamina information, etc.) stored in the player information storage unit 122 of the server device 1.

The character (unit) selection section 42 is used to select one's own character (unit) to make a sortie on the displayed screen. In the illustrated example, five types of characters A to E are selectable. In the character (unit) selection section 42, for example, selectable characters may be displayed as active, and non-selectable characters may be displayed as inactive. The characters may be set to have unique characteristics, such as a type that is good at short-range attacks or a type that is good at long-range attacks.

The menu operation unit 43 selects a setting item for performing various settings related to the game program that is executed on the player terminal 2 in response to the player's selection on the player terminal 2, accepts the player's setting for the selected setting item, and transmits and stores the setting information to the game operation information storage unit 221 of the player terminal 2 and/or the player information storage unit 121 of the server device 1 for storage. For the setting items that are set and registered by the menu operation unit 43, for example, an option setting and an automatic sake setting of possessed items, and the like are the example of a quest game. The option settings include, for example, adjustment of the respective volume of BGM, sound effects, and character voices, on/off setting of the vibration function of the player terminal 2 at the start or end of the battle, push notification setting at the time of stamina recovery, and the like, but are not limited thereto.

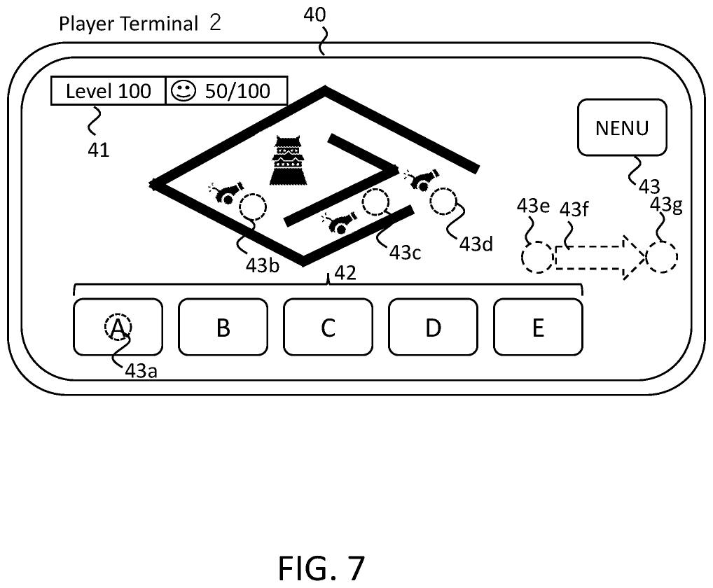

FIG. 7 is a diagram which shows an example in which the player performs a plurality of touch input operations on the touch panel 40 of the player terminal 2 on the game screen shown in FIG. 6.

In the example shown in FIG. 7, first, a touch input (tap) 43a for the character “A” button of the character (unit) selection section 42 is performed. In FIG. 7, a dotted circle is displayed at the position where the touch input (tap) 43a is performed for convenience of explanation, but such a display is not displayed on the touch panel 40 when touch input is performed.

Subsequently, touch inputs (taps) 43b, 43c and 43d are performed as operations for disposing the character “A” on the screen. These are also displayed with dotted circles at the touch input (tapped) position for convenience of explanation, but such a display is not displayed on the touch panel 40 when touch input is performed. In the example of FIG. 7, touch inputs (taps) 43b, 43c, and 43d are performed in the vicinity of three enemy gun turrets, respectively, and thus the character “A” is disposed at those positions. These touch inputs (taps) 43b, 43c and 43d can be performed, for example, one by one in sequence using one finger of the player, or they can be performed almost simultaneously using three fingers of the player. In addition, various fingers of both hands can be used to perform complex input operations which perform, for example, touch inputs at five or more positions almost simultaneously.

Further, in the example shown in FIG. 7, swipe inputs 43e to 43g are performed as touch inputs for an operation to scroll the screen. This swipe input includes input operations such as an input start 43e, a swipe movement 43f, and an input end 43g on the touch panel 40.

As operation information related to these touch inputs 43a to 43g, information including at least input positions on the touch panel 40 and respective input times is transmitted from the communication unit 25 of the player terminal 2 to the server device 1 via the network 3, and the communication unit 15 of the server device 1 receives this. The operation information received by the server device 1 is stored in the operation information storage unit 124. The above-mentioned touch inputs 43a to 43g are very few input examples of the input operations performed while the game processing is being executed by the system 1, and the operation information transmitted from the player terminal 2 to the server device 1 may also include information related to touch inputs performed before and after the touch inputs 43a to 43g. In addition, since touch input operations on the touch panel 40 of the player terminal 2 can be performed continuously at high speed, in order to accurately acquire the time of each touch input, it is preferable to record the input time information at time intervals of 0.1 second order or a shorter time than that.

The server device 1 receives, from a player terminal 2, game image data related to the image of the game application generated by the player terminal 2, while the input operation described in step S1 is being performed on the player terminal 2 during operation of the game system (step S2).

The game operation unit 212 of the player terminal 2 according to the present embodiment outputs the generated game image data to the output unit 24 and performs control processing to transmit the generated game image data from the communication unit 25 to the server device 1. Alternatively, the game operation unit 212 may be configured so as to output the generated game image data to the output unit 24, store the generated game image data in the game image storage unit 223, and perform control processing to transmit the generated game image data from the communication unit 25 to the server device 1 later.

The transmission processing of the game image data generated by the game operation unit 212 of the player terminal 2 to the server device 1 or the storage process of the game image data in the game image storage unit 223 is preferably performed in conjunction with the start/end of recording of the operation information described in step S1. For example, when a mode is selected in which the player stores operation information from the start to the end of playing the game in the operation information storage unit 124 by an input operation via the input unit 23 of the player terminal 2, the game image data from the start to the end of the game play is transmitted to the server device 1 or stored in the game image storage unit 223. When a mode is selected in which operation information from the recording start time to the recording end time instructed by the player during game play is stored in the operation information storage unit 124, the game image data from the recording start time at which the player instructs to start recording through the input unit 23 during the game play to the recording end time at which the player instructs to end recording is transmitted to the server device 1 or stored in the game image storage unit 223. The game image data transmitted from the player terminal 2 is received by the communication unit 15 of the server device 1 via the network 3 and stored in the game image storage unit 125 of the server device 1 in a state to which a unique ID is assigned.

In step S2, the server device 1 may receive from the player terminal 2 the game image data generated by the player terminal 2 executing the game application and the game music/audio data corresponding thereto. In this case, the received game music/sound is stored in the game image storage unit 125 of the server device 1 in a state of being associated with the corresponding game image data.

The operation information reproduction data generation unit 114 in the control unit 11 of the server device 1 generates operation information reproduction data that is used to synchronize the graphics corresponding to each input operation included in the operation information with the game image data and display them on the output unit 24 of the player terminal 2 based on the operation information received from the player terminal 2 in step S1 (step S3).

The operation information reproduction data includes a graphic data for visualizing the position and timing of each input operation accompanied by time information on the time axis in the original operation information and displaying it on the output unit 24 (touch panel 40) of the player terminal 2. As described above, the graphic data may be, for example, an image of “●” with any color or decoration. Graphic data used for the operation information reproduction data is stored in advance in the storage unit 12 of the server device 1, for example.

The operation information reproduction data includes display position information related to the position on the output unit 24 (touch panel 40) of the player terminal 2 where the graphic corresponding to each input operation is displayed, and display time information related to the display start time and display end time of the graphic. The display start time of the graphic is determined based on the input time information of each input operation included in the operation information. Further, the display end time of the graphic can be determined as a time after a predetermined time has elapsed from the display start time (for example, after 0.1 seconds or after 0.5 seconds). The server device 1 may be configured so that the user can appropriately set this predetermined time via the input unit 13 of the server device 1.

When the input operation is a touch input such as swiping, dragging, or flicking, in which the touch position of the user's fingertip moves on the input unit 23 (touch panel 40), the operation information reproduction data includes display time information corresponding to the start position, trajectory, and end position of the touch input, and the input time information (touch input start time, input end time, etc.) of each input operation.

The operation information reproduction data generated in this manner may be used to display the graphic for a predetermined time at the timing at which each input operation is performed on the touch panel 40 at the position where each input operation is performed on the time axis of the operation information.

The operation information reproduction data generated in this manner is stored in the storage unit in association with the corresponding game image data acquired by the server device 1 in step S2. Such association can be performed, for example, by using an association table that associates the unique ID of the operation information reproduction data with the unique ID of the game image data corresponding to the operation information reproduction data.

Subsequently, the server device 1 transmits the operation information reproduction data and game image data to the player terminal 2 in response to a request command from the player terminal 2 inputted by the player (step S4).

The player communicates with the server device 1 via the network 3 using the player terminal 2, specifies the unique ID of the operation information reproduction data to be reproduced from among the operation information reproduction data stored in the operation information reproduction data storage unit 126 of the storage unit 12 of the server device 1, and transmits its unique ID to the server device 1, thereby requesting the server device 1 to transmit the operation information reproduction data to its own player terminal 2. The recording unit 12 of the server device 1 stores a large amount of operation information reproduction data generated by operations of a large number of players and a large amount of game image data corresponding thereto. The player may search and select the operation information reproduction data generated by itself using the input unit 23 of the player terminal 2, and may search and select operation information reproduction data generated by another player using the input unit 23 of the player terminal 2. As described above, the operation information reproduction data includes, in addition to the unique ID, a game information specifying the game program in which the operation information has been inputted, a player ID of the player logged into the player terminal 2 for which the operation information has been inputted, and tag information indicating the stage of the game where the operation information was inputted, the enemy character that was defeated, and the like. The player can search for the operation information reproduction data to be reproduced with reference to such information.

When a transmission request for the unique ID of the operation information reproduction data is received from the player terminal 2, the control unit 11 of the server device 1 specifies the operation information reproduction data having the unique ID from the operation information reproduction data storage unit 126, and at the same time, identifies the unique ID of the game image data corresponding to the operation information reproduction data with the unique ID, with reference to the association information such as the association table included in the operation information reproduction data storage unit 126, and specifies the game image data having the unique ID from the game image storage unit 125. Then, the control unit 11 of the server device 1 transmits the specified operation information reproduction data and game image data to the player terminal 2 that made the request.

The player terminal 2 that has received the operation information reproduction data and the game image data synchronizes the operation information reproduction data and the game image data and reproduces and displays them on the output unit 24 (touch panel 40) of the player terminal 2 (step S5).

The reproduction data processing unit 214 of the player terminal 2 performs, for example, a process of synchronizing the operation information reproduction data and the game image data and outputting them to the output unit 24 by using at least one same time information (time stamp) common to the operation information reproduction data and the game image data received from the server device 1. Thereby, the operation information reproduction data is reproduced and displayed on the output unit 24 of the player terminal 2 together with the game image data.

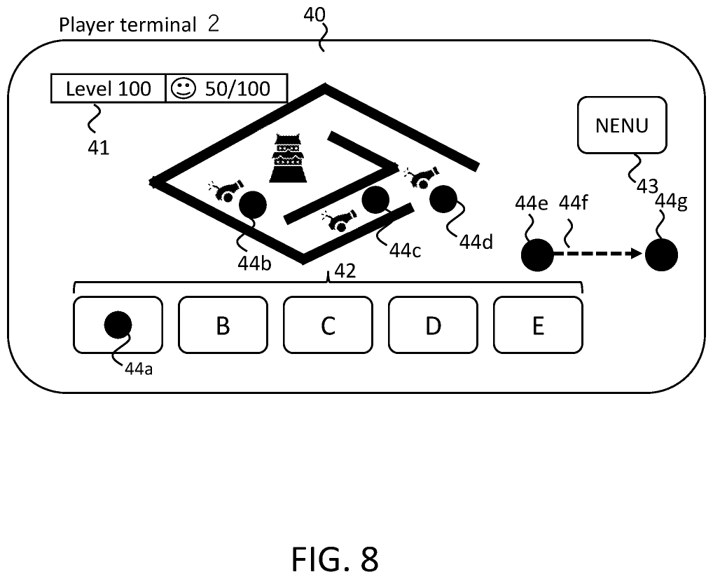

FIG. 8 is a diagram which shows an example in which operation information reproduction data and game image data are reproduced and displayed on the output unit (touch panel 40) of the player terminal 2. The reproduction display of the operation information reproduction data and the game image data shown in FIG. 8 corresponds to the operation information described with reference to FIG. 7 and the game image generated as a result of the operation information and displayed on the touch panel 40.

When the operation information reproduction data and the game image data are started to be reproduced on the touch panel 40 in a synchronized state from the respective recording start times, the “●” graphic 44a corresponding to the touch input (tap) 43a on the character “A” button of the character (unit) selection section 42 described with reference to FIG. 7 is displayed at a position on the touch panel 40 where the touch input 43a is performed based on the time information when the touch input 43a is performed. The graphic 44a disappears after a predetermined period of time such as 0.1 seconds or 0.5 seconds has elapsed from the start of the display.

Subsequently, the graphics 44b, 44c and 44d of “●” each corresponding to the touch inputs (taps) 43b, 43c and 43d are displayed at positions on the touch panel 40 where the touch inputs 43b, 43c and 43d are performed based on time information when those touch inputs are performed. For example, when the touch inputs 43b, 43c and 43d are sequentially performed, the corresponding graphics 44b, 44c and 44d are started to be displayed in that order, and when the touch inputs 43b, 43c and 43d are performed almost simultaneously, the corresponding graphics 44b, 44c and 44d are started to be displayed almost simultaneously. These graphics 44b, 44c and 44d also disappear after a predetermined time has elapsed from the start of each display.

Subsequently, graphics corresponding to the swipe inputs 43e-43g are displayed. Swipe input includes each input operation of input start 43e, swipe movement 43f, and input end 43g. A graphic 44e of “●” corresponding to the start of input 43e is started to be displayed at the position on the touch panel 40 where the start of input 43e is performed based on the time information when the input is performed, and moved to the position on the touch panel 40 where the input end 43g is performed according to the trajectory and speed of the swipe movement 43f, and then disappears after a predetermined time has passed.

The reproduction of the operation information reproduction data and the game image data ends at their recording end time.

Thus, according to the system 1 of the present embodiment, during execution of the game application on the output unit 24 (touch panel 40) of the player terminal 2, the content of each input operation performed by the player on the input unit 23 (touch panel 40) of the player terminal 2 can be visually displayed and reproduced in synchronization with the game image displayed on the output part 24 (touch panel 40) of the player terminal 2 at the time of performing the input operation.

Therefore, as an example, when a certain player retrieves the operation information reproduction data of another player in the server device 1 and reproduces it in the player terminal 2, it is possible to know what kind of input operation the other player was performing at what timing, and as a result, how the processing of the game application proceeded.

Specifically, for example, in a case where a character operated by a player attacks an enemy in a game of the action role-playing game genre, when a player selects an attack skill and performs an attack operation, an advanced player may perform input operations for selecting an attack skill and performing an attack almost simultaneously. However, since how these operations are performed is visualized by graphic display corresponding to the input operation and reproduced on the output unit 24 (touch panel 40) of the player terminal 2, other general players can look at it and improve their own input operation skills.

Further, in a so-called a first-person shooting game (FPS) or a third-person shooting game (TPS), the character is operated from the viewpoint of the character to be operated or the viewpoint from behind the character to be operated to attack enemies that appear in the game while moving freely in the game space. In the genre game, a series of input operations, such as moving operations of the character in back and forth, left and right directions, etc., change operations of the viewpoint in up and down, back and forth, left and right directions, etc., selection operations of the character's weapon item, and attack operations of the character, can be performed simultaneously and continuously at high speed. Visualizing and reproducing those input operations on the touch panel 40 is very useful for advanced players to share their own operation contents with other players, and for other players to refer to the advanced player's operation contents. In particular, when the input operations performed are fast and complicated, it is possible to study which finger should be used to perform such an input operation by looking at the reproduction of operation information reproduction data and game image data.

As another example, when a certain player retrieves its own operation information reproduction data on the server device 1 and reproduces it on the player terminal 2, the player can look back and check what kind of input operation the player performed in one scene of the game application played before.

Players can improve their own game play skills by imitating the operations performed by advanced players and reviewing their own operations, and as a result, motivation to keep playing the game can be given to the player.

The reproduction data processing unit 214 of the player terminal 2 may be configured to be able to change the reproduction speed of the operation information reproduction data and the game image data in response to input by the player from the input unit 23. Thereby, for example, when the player inputs into the input unit 23 to slow down the reproduction speed, and the operation information reproduction data and the game image data are slowly reproduced at a speed slower than an actual speed. It becomes possible to visually recognize the input operation continuously performed at high speed in more detail.

Regarding the operation information and game image data stored in the operation information storage unit 124 and the game image storage unit 125 in steps S1 and S2 described above, after the completion of the storage operation, the control unit 11 of the server device 1 may be configured so as to perform a processing of: displaying on the output unit 24 of the player terminal 2 a screen that prompts the player to select whether to preserve or delete the operation information and the game image data stored in the operation information storage unit 124 and the game image storage unit 125; storing the operation information and the game image data in the operation information storage unit 124 and the game image storage unit 125 according to the selection input on the input unit 23 of the player terminal 2; or deleting them from the storage unit. Alternatively, the control unit 11 of the server device 1 does not request such a selection each time operation information and game image data are stored, but rather the most recent several operation information and game image data are stored in the operation information storage unit 124 and the game image storage unit 125, and may be configured so as to perform a process of allowing the player to select saving and deleting from among them on the player terminal 2. When the server device 1 is configured as described above, the operation information reproduction data generation unit 114 of the server device 1 may be configured to generate operation information reproduction data for the operation information and game image data selected to be saved.

Next, various examples of the present embodiment will be described.

### EXAMPLE 1

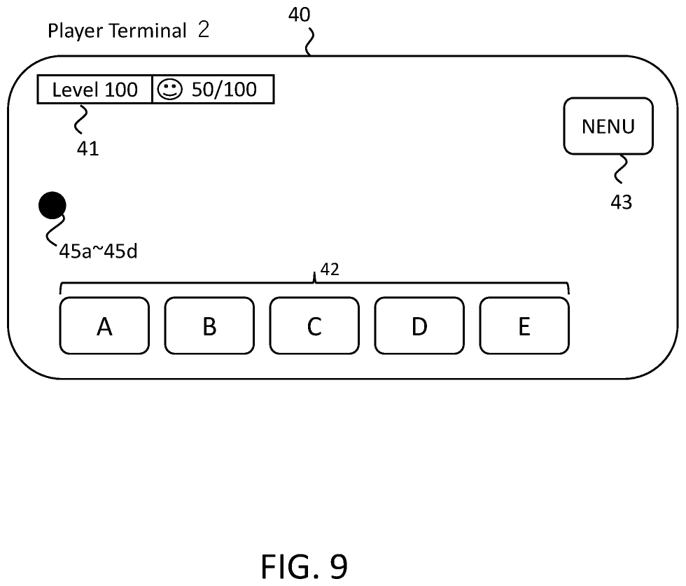

FIG. 9 is a diagram which shows another example in which operation information reproduction data and game image data are reproduced and displayed on the output unit (touch panel 40) of the player terminal 2.

In the example shown in FIG. 8, a graphic may be displayed so as to reproduce the position and timing on the touch panel 40 where the input operation was performed by the player. On the other hand, the game application that the player was playing is mainly operated by tap input, and if it is a so-called rhythm game type in which operations are performed only by timing regardless of the tap input position, there is no need to display graphics at the input position when reproducing the player's input operation. In such a case, the reproduction data processing unit 214 of the player terminal 2 displays graphics corresponding to various tap operations at arbitrary positions on the output unit (touch panel 40) of the player terminal 2 as shown in FIG. 9. The graphic may be continuously displayed in accordance with the input timing of each tap operation.

FIG. 9 shows an example in which graphics 45a to 45d are continuously displayed when five tap operations are performed in sequence. In the example shown in FIG. 9, the graphics 45a to 45d are displayed on the left area of the touch panel 40. Since each graphic ends its display (disappears) after a predetermined period, the graphics 45a to 45d do not continue to overlap on the touch panel 40, and the player can visually recognize that the graphics 45a to 45d are continuously displayed.

The reproduction data processing unit 214 of the player terminal 2 switches between a mode in which graphics corresponding to various touch inputs are displayed at touch input positions on the touch panel 40 in response to inputs from the input unit 23 by the player, and the mode of displaying at a predetermined position on the touch panel 40.

### EXAMPLE 2

According to the example described with reference to FIGS. 8 and 9, during execution of the game application on the output unit 24 (touch panel 40) of the player terminal 2, the content of each input operation performed by the player on the input unit 23 (touch panel 40) of the player terminal 2 can be visually displayed and reproduced in synchronization with the game image displayed on the output part 24 (touch panel 40) of the player terminal 2 at the time of performing the input operation, based on the time information when those inputs are performed at the positions on the touch panel 40 where those input operations are performed. At this time, the player viewing the reproduced display on the player terminal 2 touches the graphic display position in accordance with the visualized display (graphic) of the reproduced input operation, thereby performing a practice for improving the input operation skill by imitating the input operation that is reproduced and displayed.

In the present embodiment, in the player terminal 2, while the reproduction data processing unit 214 causes the output unit 24 (touch panel 40) to reproduce and display the operation information reproduction data and the game image data, the operation information reception unit 211 (touch panel 40) receives a touch input operation by the player. The control unit 21 of the player terminal 2 compares the position and timing of each touch input by the player on the input unit 23 (touch panel 40) with the position and timing of each graphic reproduced and displayed on the output unit 24 (touch panel 40) based on the operation information reproduction data, and determines whether each touch input by the player on the input unit 23 (touch panel 40) is equivalent to a so-called model input operation indicated by the graphic display based on a predetermined standard. The determination result may be configured to be displayed on the output unit 24 (touch panel 40).

A predetermined standard, for example, a position deviation range and a timing deviation range of the touch input with respect to the graphic display can be set within a predetermined numerical value, respectively. Further, determination based on predetermined standard may be performed for each input operation, and the determination result may be displayed on the output unit 24 (touch panel 40) for each input operation, or may be performed comprehensively after all the input operations in the operation information reproduction data are reproduced, and the results may be displayed.

According to the present embodiment, by touching the graphic display position in accordance with the visualization display (graphic) of the input operation reproduced on the output unit 24 (touch panel 40) of the player terminal 2, a so-called “practice mode” can be provided that mimics the replayed input operations. Further, by presenting the result of comparing the reproduced input operation and the imitated input operation on the output unit 24 (touch panel 40), the player can know whether the imitated input operation is equivalent to the model input operation. The reason why the control unit 21 of the player terminal 2 can compare the reproduced input operation and the imitated input operation as in the present embodiment is because the operation information reproduction data includes display position information and display time information for displaying a graphic that visually displays the input operation.

Further, while the reproduction data processing unit 214 allows the output unit 24 (touch panel 40) to reproduce and display the operation information reproduction data and the game image data, the touch input operation received by the operation information receiving unit 211 may be configured to be displayed together with graphics reproduced on the output unit 24 (touch panel 40) based on the operation information reproduction data and to be visualized using additional graphics. Further graphics are, for example, graphics displayed based on the operation information reproduction data in a different color or overlapping portions with the graphics displayed based on the operation information reproduction data are omitted, thereby making a graphic of a shape that shows only the difference part from the graphic.

### EXAMPLE 3

A large number of operation information reproduction data and game image data generated by various players can be accumulated in the storage unit 12 of the server device 1. When a player wants to view the contents of game operations performed by advanced players, displaying rankings that reflect the voting results by other players previously viewed makes it easier for the player to retrieve the contents of game operations. On the other hand, for the player, the display of its own game operation content at a high ranking motivates the player to play more games in order to improve more advanced input operation techniques.

In the present embodiment, the input unit 23 of the player terminal 2 is configured so as to accept the player's evaluation of the operation information reproduction data transmitted and reproduced from the server device 1 to the player terminal 2. The player's evaluation is inputted, for example, by selecting from five levels of 1 to 5, or by two selections of high evaluation “Good” and low evaluation “Bad”. The player evaluation input by the input unit 23 is transmitted to the server device 1, and is stored, for example, in the operation information reproduction data storage unit 126 in association with the operation information reproduction data on which the player evaluation has been performed. A large number of player evaluations performed by a large number of players for certain operation information reproduction data are accumulated and stored in the operation information reproduction data storage unit 126.

When a certain player accesses the server device 1 using the player terminal 2 to retrieve the operation information reproduction data to be viewed, a plurality of operation information reproduction data is presented as a search result in the output section 24 of the player terminal 2. Those control information reproduction data may be presented in a ranked state according to the associated player evaluation. The player can select operation information reproduction data to be viewed with reference to those player evaluations.

In the present embodiment, the operation information reproduction data including the associated player evaluation and the game image data may also be provided from the server device 1 via the network 3 to persons other than users of the game system. As a result, more viewers can view the operation information reproduction data and the game image data, and more player evaluations can be obtained. The operation information reproduction data and game image data may be published via various social networking services (SNS).

The above-mentioned embodiments and examples are merely examples for facilitating understanding of the present invention and should not be construed as limiting the present invention. It goes without saying that modification and improvement can be made to the present invention without departing from the spirit thereof, and that an equivalent thereof is included in the present invention. Further, the features shown in the embodiments and examples are applicable to other embodiments and examples as long as they are not mutually contradictory.

Further, the effects described herein are merely explanatory or exemplary and are not limited. That is, the techniques according to the present disclosure may have other effects apparent to those skilled in the art from the description herein, in addition to or in place of the above effects.

### DESCRIPTION OF REFERENCE NUMERALS

1: server device

2: player terminal

3: network

1. An information processing method by computer comprising:
a step of acquiring operation information relating to a touch input operation inputted into a player terminal equipped with a touch panel;
a step of acquiring game image data relating to an image of a game application generated by the player terminal while the touch input operation is performed on the player terminal;
a step of generating operation information reproduction data for visually displaying the touch input operation included in the operation information on the player terminal on the basis of the operation information; and
a step of synchronizing the operation information reproduction data and the game image data associated with the operation information reproduction data in response to a reproduction request from the player terminal, and reproducing and displaying them on the player terminal,
wherein the step of generating operation information reproduction data includes allowing display position information for displaying a visualization display corresponding to each of touch input operations included in the operation information in accordance with touch input position information of each of the touch input operations to be included in the operation information reproduction data.

2. The information processing method according to claim 1, wherein the step of generating operation information reproduction data includes allowing display time information for displaying the visualization display corresponding to each of the touch input operations included in the operation information in accordance with input time information of each of the touch input operations to be included in the operation information reproduction data.

3. The information processing method according to claim 1, further comprising:
a step of receiving an input operation inputted into the player terminal while the operation information reproduction data and the game image data are reproduced; and
a step of comparing the input operation with the touch input operation included in the operation information reproduction data and presenting the comparison result.

4. The information processing method according to claim 1, further comprising a step in which an input operation inputted into a player terminal while the operation information reproduction data and the game image data are reproduced, is visually displayed in the output of the player terminal along with the visualization display of the touch input operation included in the operation information reproduction data.

5. The information processing method according to claim 1, further comprising:
a step of acquiring player evaluation information inputted into the player terminal that has reproduced the operation information reproduction data and the game image data;
a step of storing the player evaluation information for the reproduced operation information reproduction data in a storage unit in association with the operation information reproduction data; and
a step of presenting the operation information reproduction data stored in the storage unit to the player terminal together with the associated player evaluation information.

6. A program for making a computer execute an information processing method, the information processing method comprising:
a step of acquiring operation information relating to a touch input operation inputted into a player terminal equipped with a touch panel;
a step of acquiring game image data relating to an image of a game application generated by the player terminal while the touch input operation is performed on the player terminal;
a step of generating operation information reproduction data, based on the operation information, for visually displaying the touch input operation included in the operation information on the player terminal;
a step of synchronizing the operation information reproduction data and the game image data associated with the operation information reproduction data in response to a reproduction request from the player terminal, and reproducing and displaying them on the player terminal,
wherein the step of generating operation information reproduction data includes allowing display position information for displaying a visualization display corresponding to each of touch input operations included in the operation information in accordance with input position information of each of the touch input operations to be included in the operation information reproduction data.

7. An information processing system having a control unit, in which the control unit is configured so as to include:
acquiring operation information related to a touch input operation inputted into a player terminal equipped with a touch panel;
acquiring game image data relating an image of a game application generated by the player terminal while the touch input operation is performed on the player terminal;
generating operation information reproduction data for visually displaying the touch input operation included in the operation information on the player terminal based on the operation information; and
synchronizing the operation information reproduction data and the game image data associated with the operation information reproduction data in response to a reproduction request from the player terminal, and reproducing and displaying them on the player terminal,
wherein generating operation information reproduction data includes allowing display position information for displaying a visualization display corresponding to each of touch input operations included in the operation information in accordance with input position information of each of the touch input operations to be included in the operation information reproduction data.
